(19) United States
(12) Patent Application Publication
(10) Pub. No.: US 2024/0079678 A1
(43) Pub. Date: Mar. 7, 2024

(54) ENERGY STORAGE APPARATUS

(71) Applicant: LG Electronics Inc., Seoul (KR)

(72) Inventors: Heejoong Jang, Seoul (KR); Dongkeun Yang, Seoul (KR); Hyoungsuk Woo, Seoul (KR)

(21) Appl. No.: 18/242,162

(22) Filed: Sep. 5, 2023

(30) Foreign Application Priority Data
Sep. 6, 2022 (KR) 10-2022-0112796

(51) Int. Cl. H01M 10/6568; H01M 10/44; H01M 10/613; H01M 10/6551; H01M 10/6556

(52) U.S. Cl. CPC H01M 10/6568; H01M 10/441; H01M 10/613; H01M 10/6551; H01M 10/6556

(57) ABSTRACT

An energy storage apparatus may include: a casing; a battery pack disposed inside the casing, and having a plurality of battery cells; a power converter disposed inside the casing; a pump that supplies cooling water to the battery pack or the power converter; and a heat radiator that cools cooling water flowing from the battery pack or the power converter. The heat radiator may include: a cooling water pipe in which cooling water flows; a heat sink that contacts with the cooling water pipe and having a plurality of heat sink fins disposed on the other side; a heat sink fan for forming an air flow to the plurality of heat sink fins; and a cover plate spaced from the heat sink, and formed with communicating holes.

### CROSS-REFERENCE TO RELATED APPLICATION

This application claims priority under 35 U.S.C. § 119 to Korean Application No. 10-2022-0112796, filed on Sep. 6, 2022, whose entire disclosure is hereby incorporated by reference.

### BACKGROUND

### 1. Field

The present disclosure relates to an energy storage apparatus and, more particularly, to an energy storage apparatus that includes a heat radiator for dissipating heat from cooling water which cools a battery pack.

### 2. Background

An energy storage apparatus may be provided in a living space or office to store electricity generated in that space and supply electric power to it.

An energy storage apparatus may include a battery, a power converter for changing or stabilizing electric power supplied to the battery, and etc. Since heat is generated from the battery or the power converter provided inside the energy storage apparatus, a cooling device may be included to lower the temperature.

The cooling device in the energy storage apparatus may perform cooling through air or cooling water. The cooling device using cooling water may include a pump for moving cooling water and a heat radiator for decreasing the temperature of cooling water in which temperature has been raised.

The heat radiator may require a room (or area) of a certain size or larger to form a space where outside air flows. To improve the performance of the heat radiator, a volume of a duct in which outside air flows may need to be increased. However, this is not applicable in a limited space of the energy storage apparatus.

U.S. Pat. No. 8,448,696 B2, the subject matter of which is incorporated herein by reference, discloses a water-cooling type structure for cooling a battery by using a cooling solution.

### BRIEF DESCRIPTION OF THE DRAWINGS

Arrangements and/or embodiments may be described in detail with reference to the following drawings in which like reference numerals refer to like elements and wherein:

FIG. 1 is a perspective view of an energy storage apparatus according to an embodiment of the present disclosure;

FIG. 2 is a system diagram of an energy storage apparatus according to an embodiment of the present disclosure;

FIG. 3 is a front view of a heat radiator according to an embodiment of the present disclosure;

FIG. 4 is a side cross-sectional view of a heat radiator according to an embodiment of the present disclosure;

FIG. 5 is a view showing a state in which a heat sink fan and a cover plate are removed, in order to explain arrangement of the heat sink fins;

FIG. 6 is a view showing a state in which the heat sink fins and the cover plate are removed, in order to explain arrangement of the heat sink fins;

FIG. 7 is a view for explaining configuration and arrangement of a cooling water pipe according to an embodiment (different from FIG. 6);

FIG. 8 is a view for explaining flow of cooling water in a first cooling mode;

FIG. 9 is a view for explaining flow of cooling water in a second cooling mode;

FIG. 10 is a view for explaining flow of cooling water in a preheating mode; and

FIG. 11 is a sequential chart for explaining a method of controlling an energy storage apparatus according to an embodiment of the present disclosure.

### DETAILED DESCRIPTION

Advantages and features of the present disclosure and methods for achieving them will be made clear from the embodiments described below in detail with reference to the accompanying drawings. The present disclosure may, however, be embodied in many different forms, and should not be construed as being limited to the embodiments set forth herein. Rather, these embodiments are provided so that this disclosure will be thorough and complete, and will fully convey the scope of the present disclosure to those skilled in the art. The present disclosure is merely defined by the scope of the claims. Like reference numerals refer to like elements throughout the specification. The present disclosure will be described with reference to the drawings for explaining an energy storage apparatus according to embodiments of the present disclosure.

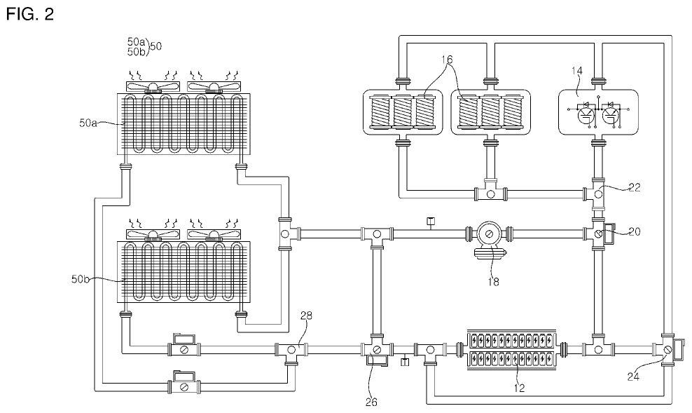

An energy storage apparatus may include a casing 10, a battery pack 12 (FIG. 2) disposed inside the casing and having a plurality of battery cells provided therein, a power converter 14 (FIG. 2) (PCS: Power Conditioning System) for converting electrical characteristics to charge and/or discharge the battery cells disposed in the battery pack 12, and a reactor 16 (FIG. 2) for stabilizing an abrupt change in current.

The casing 10 may include a rear wall 10a, a front wall 10b, an upper wall 10c, a lower wall 10d, and side walls 10e. As one example, the front wall 10b may be a door that is rotatably disposed on one of the side walls 10e. A heat radiator 50 may be disposed on one of the side walls 10e. In a different arrangement, the heat radiator 50 may be disposed on the rear wall 10a or the upper wall 10c.

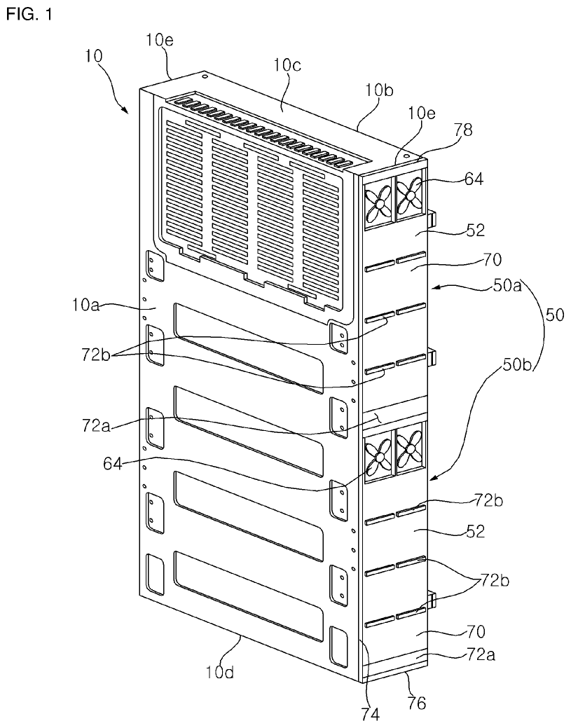

The energy storage apparatus may include a pump 18 for supplying (or providing) cooling water (or cooling liquid) to the battery pack 12 or the power converter 14, and the heat radiator 50 for dissipating heat from cooling water that is caused to flow by the pump 18. FIG. 1 shows the heat radiator 50 disposed on one side of the casing 10.

The heat radiator 50 may be provided in such a way as to cover one side of the casing 10. Referring to FIGS. 1 and 2, the heat radiator 50 may include a first heat radiator 50a and a second heat radiator 50b disposed below the first heat radiator 50a. In the following disclosure, terms such as a vertical direction and a horizontal direction may be used. These terms may be based on the structure of FIG. 1 extending in the vertical direction (i.e., upwards). For example, the first radiator 50a may be above the second heat radiator 50b in the vertical direction. However, other directions may be used. Additionally, the terms vertical direction and horizontal direction may be reversed. The terms vertical and horizontal as used in the following disclosure are merely one example of two different directions.

The first heat radiator 50a and the second heat radiator 50b each may be disposed on one side of the casing 10. FIG. 1 shows the first heat radiator 50a and the second heat radiator 50b may be disposed on the same one side of the casing 10.

The energy storage apparatus may include a regulating valve 28 that selectively supplies cooling water flowing from the pump 18 to either the first heat radiator 50a or the second heat radiator 50b, or to both of the first and second heat radiators 50a and 50b.

The energy storage apparatus may include a first switching valve 20 for selectively sending the cooling water caused to flow by the pump 18 to the power converter 14 or the battery pack 12, and a second switching valve 22 for selectively sending cooling water flowing through the first switching valve 20 to the power converter 14 and/or to the reactor 16.

The energy storage apparatus may include a first bypass valve 24 for selectively sending or bypassing cooling water discharged from the power converter 14 or the reactor 16, and a second bypass valve 26 for selectively sending or bypassing cooling water to be supplied to the heat radiator 50.

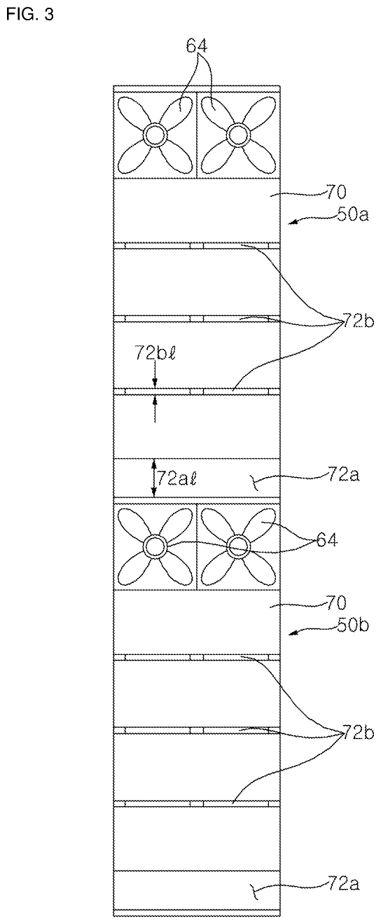

The heat radiator 50 of the present disclosure will be described in detail with reference to FIGS. 3 to 7.

FIG. 3 shows the heat radiator 50 includes the first heat radiator 50a and the second heat radiator 50b disposed below the first heat radiator 50a. The first heat radiator 50a and the second heat radiator 50b may have the same configuration. The configuration of the heat radiator 50 to be described below may selectively apply to each of the first and second heat radiators 50a and 50b.

The heat radiator 50 may include a cooling water pipe 56 (or cooling pipe), a heat sink 60, a heat sink fan 64, and a cover plate 70. The cooling water pipe 56 may be a pipe in which cooling water flows. Alternatively, the cooling water pipe (or cooling pipe) may be any one of a tube, a conduit, a hose, a duct, a channel, etc. The heat sink 60 is configured such that a first side of the heat sink (i.e., a first physical side) comes into contact with the cooling water pipe 56 and a plurality of heat sink fins 62 are disposed on a second side of the heat sink (i.e., a second physical side).

The heat sink fan 64 is disposed (in a horizontal direction) on one side of the heat sink 60, and provides an air flow to the plurality of heat sink fins 62 (or through the separate fins or by the fins). The cover plate 70 is spaced a predetermined distance from the heat sink 60, and is formed to have communicating holes 72a and 72b through which air flows to the heat sink fins 62.

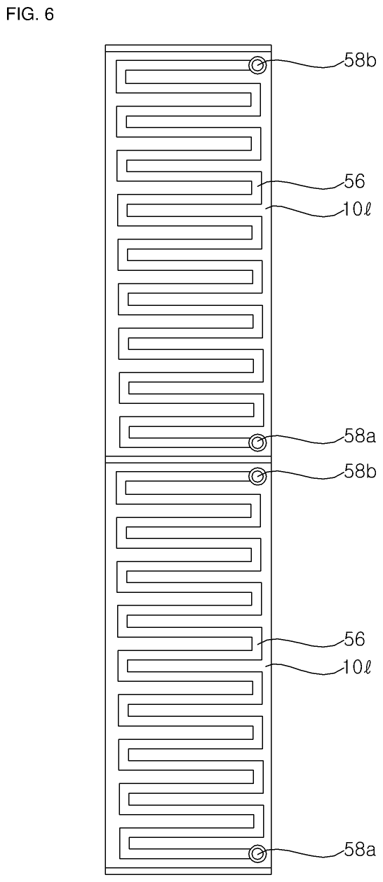

The cooling water pipe 56 is disposed outside of the casing 10. FIG. 6 shows the cooling water pipe 56 may include a plurality of bends (such as by bent structures). The cooling water pipe 56 has an inlet opening 58a formed at a lower end of the cooling water pipe and an outlet opening 58b formed at an upper end of the cooling water pipe.

The cooling water pipe 56 may be disposed between the side wall 10e of the casing 10 and the heat sink 60 of the heat radiator 50. The cooling water pipe 56 may be provided so as to come into direct contact with the heat sink 60.

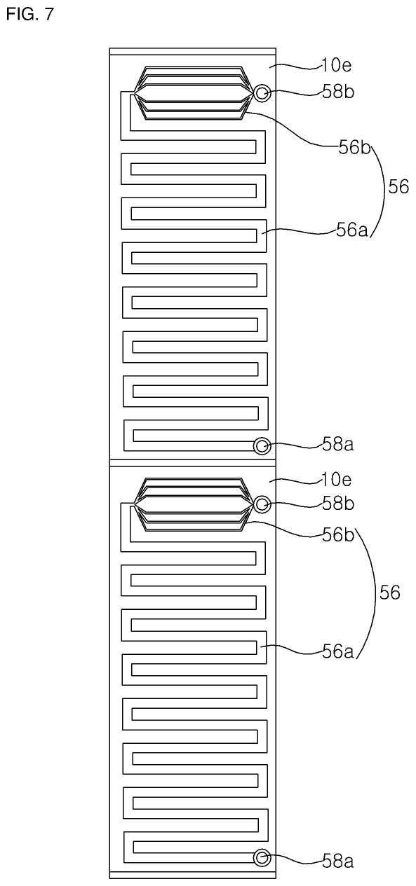

FIG. 7 shows the cooling water pipe 56 includes a first cooling water pipe 56a and a second cooling water pipe 56b disposed above the first cooling water pipe 56a. The first cooling water pipe 56a may be disposed (in a horizontal direction) on one side of the cover plate 70. The second cooling water pipe 56b extends from the first cooling water pipe 56a, and may be disposed (in a horizontal direction) on one side of the heat sink fan 64.

The second cooling water pipe 56b may include a plurality of small-bore tubes connected in parallel. An inner pipe diameter of the second cooling water pipe 56b may be smaller than an inner pipe diameter of the first cooling water pipe 56a.

The heat sink 60 may be disposed on an outer side of the cooling water pipe 56. The heat sink 60 may be provided so as to come into direct contact with the cooling water pipe 56. The heat sink 60 may be provided so as to cover the cooling water pipe 56. An upper end of the heat sink 60 may be disposed higher (in a vertical direction) than the upper end of the cooling water pipe 56, and a lower end of the heat sink 60 may be disposed lower than the lower end of the cooling water pipe 56.

The first side of the heat sink 60 may directly contact the cooling water pipe 56. A plurality of heat sink fins 62 may be disposed on the second side of the heat sink 60 (and do not come into contact with the cooling water pipe 56). The plurality of heat sink fins 62 may be configured to protrude from the second side of the heat sink 60, and each protruding fin may extend vertically. The heat sink fins 62 may include first heat sink fins 62a disposed (in a horizontal direction) on one side of the cover plate 70, and second heat sink fins 62b disposed (in the horizontal direction) on one side of the heat sink fan 64.

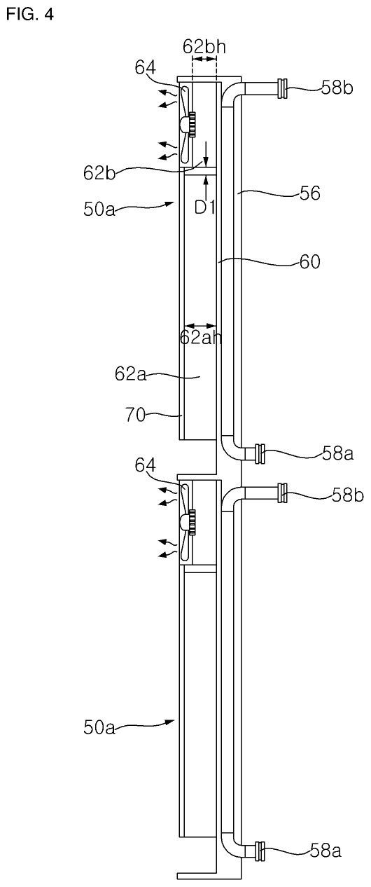

FIG. 4 shows the first heat sink fins 62a protrude a length 62ah from the heat sink 60 and the second heat sink fins 62b protrude a length 62bh from the heat sink 60. The length 62ah may be larger than the length 62bh. A length 62al that the first heat sink fins 62a extend vertically may be larger than a length 62bl that the second heat sink fins 62b extend vertically.

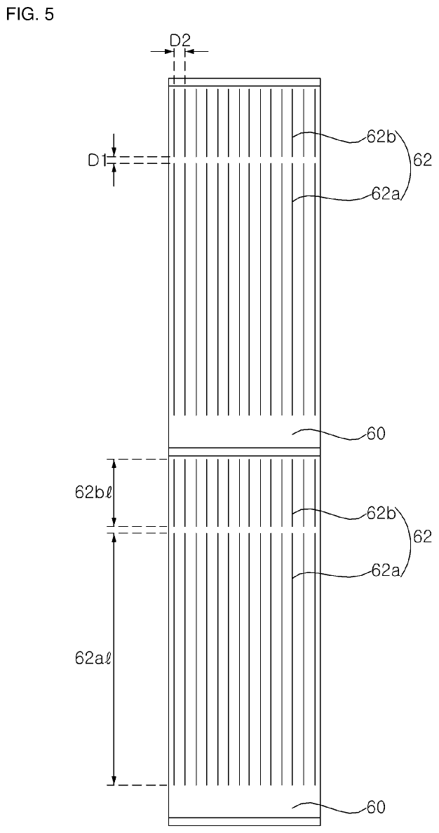

FIG. 5 shows the first heat sink fins 62a may be vertically spaced apart from the second heat sink fins 62b. The distance D1 in which the first heat sink fins 62a are spaced apart from the second heat sink fins 62b may be smaller than the distance D2 in which the plurality of first heat sink fins 62a are spaced apart from each other. The first heat sink fins 62a may each extend vertically in an area between the cover plate 70 and the heat sink.

The cover plate 70 may have a plurality of communicating holes 72a and 72b. FIG. 3 shows the cover plate 70 may have a first communicating hole 72a formed below the heat sink fins 62 and a plurality of second communicating holes 72b disposed higher than the first communicating hole 72a.

The first communicating hole 72a may have a larger area than the second communicating holes 72b. FIG. 3 shows a length 72al (in the vertical direction) of the first communicating hole 72a is larger than a length 72bl (in the vertical direction) of each of the second communicating holes 72b. The distance that the first communicating hole 72a is spaced apart from the heat sink fan 64 may be larger than the distance that the second communicating holes 72b are spaced apart from the heat sink fan 64.

The heat sink fan 64 may be an axial fan. Two heat sink fans 64 spaced apart from each other (in a horizontal manner) may be disposed in a direction perpendicular to the direction in which the heat sink fins 62 extend. The heat sink fan 64 may be disposed (in a horizontal direction) on one side of the second heat sink fins 62b.

When the heat sink fan 64 is actuated, air may be admitted inside (or sucked inside) via the first communicating hole 72a and the second communicating holes 72b. The term “inside” may refer to a space between the cover plate 70 and the heat sink 60.

The heat radiator 50 may include a housing 52 that forms a heat exchange space 54. The housing 52 may include the cover plate 70. The housing 52 may include the cover plate 70, a pair of side plates 74, a base plate 76, and an upper plate 78.

The plurality of communicating holes 72a and 72b may be provided in the cover plate 70. The pair of side plates 74 extend to the casing 10 from both side edges of the cover plate 70. The base plate 76 extends to the casing 10 from a lower end portion of the cover plate 70. The upper plate 78 extends to the casing 10 from an upper end portion of the heat sink fan 64.

The heat exchange space 54 may be formed inside the housing 52. The heat exchange space 54 may be divided into a first chamber 54a and a second chamber 54b by the heat sink 60. The cooling water pipe 56 may be disposed in the first chamber 54a. The cooling water pipe 56 disposed in the first chamber 54a may be provided so as to come into direct contact with the heat sink 60.

The plurality of heat sink fins 62 may be disposed in the second chamber 54b. The plurality of heat sink fins 62 may be spaced out in a direction perpendicular to a vertical direction. The plurality of heat sink fins 62 may guide the air admitted into (or through) the plurality of communicating holes 72a and 72b to the heat sink fan 64.

<Operation>

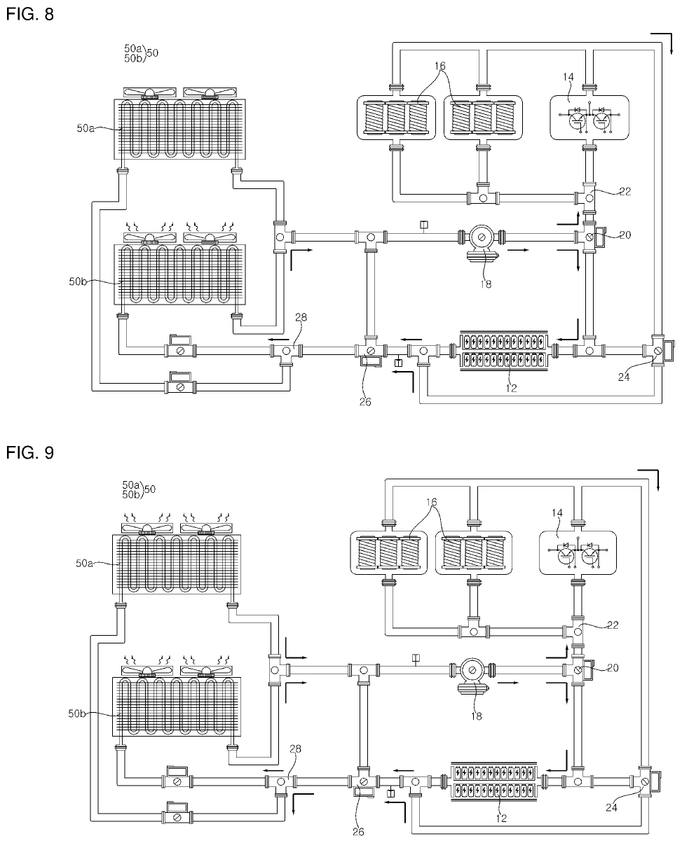

The energy storage apparatus of the present disclosure may operate in a plurality of modes. Referring to FIGS. 8 to 10, the energy storage apparatus may operate in a first cooling mode CM1, a second cooling mode CM2, and a preheating mode HM.

The first cooling mode CM1 and the second cooling mode CM2 may be differentiated depending on a temperature of cooling water. If the temperature of cooling water to be supplied to the heat radiator 50 is less than or equal to a set temperature, the first cooling mode CM1 may be performed to supply cooling water to the second heat radiator 50b alone (i.e., only the second heat radiator and without the first heat radiator). If the temperature of cooling water to be supplied to the heat radiator 50 is greater than the set temperature, the second cooling mode CM2 may be performed to supply cooling water to both the first heat radiator 50a and the second heat radiator 50b.

FIG. 8 shows that in the first cooling mode CM1, cooling water may be provided to the second heat radiator 50b alone. As the pump 18 is actuated, cooling water may flow to cool the power converter 14 and/or the battery pack 12. After exchanging heat in the power converter 14 and/or the battery pack 12, the cooling water may flow to the second heat radiator 50b, and heat may be dissipated from the cooling water (so as to be cooled). The regulating valve 28 may supply (or direct) the cooling water flowing from the battery pack 12 and/or the power converter 14 to the second heat radiator 50b.

FIG. 9 shows that in the second cooling mode CM2, cooling water may be sent to each of the first and second heat radiators 50a and 50b. As the pump 18 is actuated, the cooling water passes through the power converter 14 and/or the battery pack 12, and may pass through the regulating valve 28 to be supplied to the first heat radiator 50a and the second heat radiator 50b. After exchanging heat in the power converter 14 and/or the battery pack 12, the cooling water may be cooled in each of the first and second heat radiators 50a and 50b. The regulating valve 28 may supply (or direct) the cooling water (flowing from the battery pack 12 and/or the power converter 14) to each of the first and second heat radiators 50a and 50b.

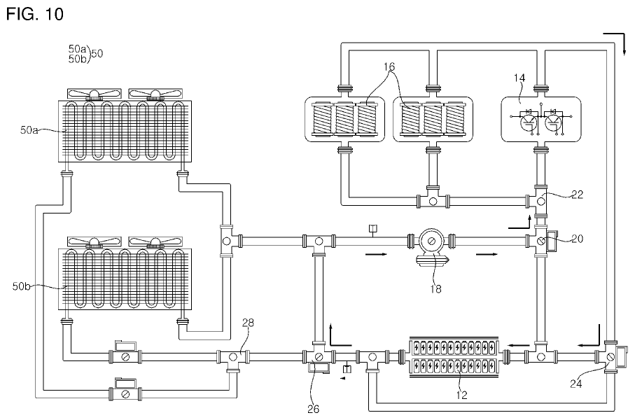

FIG. 10 shows that in the preheating mode HM, cooling water is not sent to the first heat radiator 50a and the second heat radiator 50b. Additionally, the heat sink fan 64 of each of the first and second heat radiators 50a and 50b may not be actuated.

By means of the pump 18, the cooling water may be driven to flow to the power converter 14 and the battery pack 12. The cooling water may flow to supply heat from the power converter 14 or the reactor 16 to the battery pack 12.

The second bypass valve 26 bypasses the cooling water from being supplied to the first heat radiator 50a and the second heat radiator 50b such that the cooling water is supplied to the pump 18.

<Control>

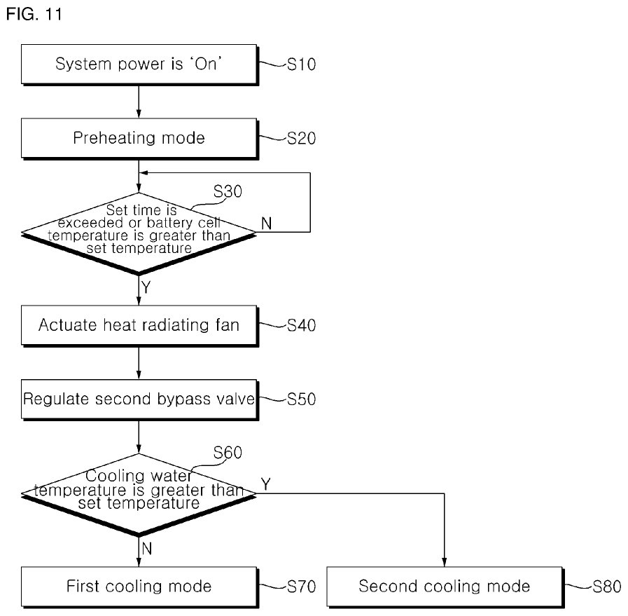

A method of controlling an energy storage apparatus according to the present disclosure will be described with reference to FIG. 11.

The method of controlling an energy storage apparatus may include activating system power (S10). The energy storage apparatus may perform a preheating mode HM for preheating the battery pack 12 and/or the power converter 14 by regulating a flow path of cooling water (S20). The preheating mode HM may be performed with respect to a time after the system power is activated. The preheating mode HM may be performed with respect to a temperature of the plurality of battery cells disposed in the battery pack 12.

If a preset time is exceeded or the temperature of the battery cells is greater than a set temperature (S30), then the first cooling mode CM1 or the second cooling mode CM2 may be enabled. At this point, the heat sink fan 64 may be actuated (S40), and the second bypass valve 26 may be regulated so that cooling water flows to the first heat radiator 50a and/or the second heat radiator 50b.

The flow of cooling water may be regulated by adjusting the regulating valve 28 according to a temperature of cooling water flowing to the first heat radiator 50a and/or the second heat radiator 50b.

The first heat radiator 50a and/or the second heat radiator 50b may sense a temperature of flowing cooling water. When the sensed temperature of cooling water is less than or equal to a set temperature (S60), then the first cooling mode CM1 may be enabled (S70). When the sensed temperature of cooling water is greater than the set temperature, then the second cooling mode CM2 may be enabled (S80).

The present disclosure provides an energy storage apparatus that improves heat dissipation performance for releasing heat from cooling water.

The present disclosure provides an energy storage apparatus that increases a heat dissipation area of a cooling water for allowing cooling water to flow in a heat radiator.

The present disclosure provides an energy storage apparatus that increases volume of flow of air admitted to exchange heat with cooling water.

The present disclosure provides effective control of power consumption of an energy storage apparatus by regulating operation of each of a plurality of heat radiators according to a temperature of cooling water.

To accomplish the above aspects, an exemplary embodiment of the present disclosure provides an energy storage apparatus including: a casing; a battery pack disposed inside the casing, with a plurality of battery cells placed therein; a power converter disposed inside the casing, for converting electrical characteristics to charge or discharge the plurality of battery cells; a pump that supplies cooling water to the battery pack or the power converter; and a heat radiator that cools cooling water flowing from the battery pack or the power converter, wherein the heat radiator includes: a cooling water pipe in which cooling water flows; a heat sink configured in such a way that one side comes into contact with the cooling water pipe and a plurality of heat sink fins are disposed on the other side; a heat sink fan disposed on one side of the heat sink, for forming an air flow to the plurality of heat sink fins; and a cover plate spaced a predetermined distance from the heat sink, and formed with communicating holes through which air flows to the heat sink fins. Thus, cooling water that has absorbed heat generated from the battery pack or the power converter may be effectively cooled.

The plurality of heat sink fins may protrude in a direction in which the cover plate is disposed.

The plurality of heat sink fins may extend vertically, and be spaced out in a direction perpendicular to the vertical direction. Thus, air admitted through the communicating holes in the cover plate may be guided to the heat sink fan.

A plurality of communicating holes spaced out vertically may be disposed on the cover plate. Thus, outside air is admitted in a plurality of areas, thereby improving overall cooling performance.

The cover plate may be formed with a first communicating hole and a second communicating hole disposed above the first communicating hole, and the first communicating hole may have a larger aperture area than the second communicating hole. Thus, air may be smoothly drawn into the first communicating holes which are formed remotely from the heat sink fan.

The second communicating hole may include a plurality of second communicating holes spaced out vertically. Thus, outside air is admitted in a plurality of areas, thereby improving overall cooling performance.

The plurality of heat sink fins may be disposed above the first communicating hole. Thus, the radiating fins may be disposed in an area where a flow path is formed between the cover plate and the heat sink fan.

The heat sink fan may be disposed above the cover plate.

The cooling water pipe may be disposed between the casing and the heat sink plate, and include a plurality of bending portions. This may increase the area of cooling water flow, thereby improving the cooling water's capability of releasing heat to the outside.

The cooling water pipe may include: a first cooling water pipe disposed on one side of the cover plate; and a second cooling water pipe that extends from the first cooling water pipe and is disposed on one side of the heat sink fan, wherein the second cooling water pipe has a structure in which a plurality of small-bore tubes are connected in parallel. As a result, the flow of the cooling water flowing inside the second cooling water pipe disposed adjacent to the area where the heat sink fan is disposed may be quickly formed.

The heat radiator may include: a first heat radiator; and a second heat radiator disposed below the first heat radiator, wherein the first heat radiator and the second heat radiator each includes the cooling water pipe, the heat sink where the plurality of heat sink fins are disposed, the heat sink fan, and the cover plate. Thus, the heat radiator may be placed in two areas.

The energy storage apparatus may further include a regulating valve that sends cooling water flowing from the pump to either the first heat radiator or the second heat radiator or both of the first and second heat radiators. Thus, the first heat radiator and the second heat radiator may be actuated individually or simultaneously.

If the temperature of cooling water flowing to the heat radiator is less than or equal to a set temperature, the regulating valve may be adjusted to supply cooling water to the second heat radiator alone. Thus, unnecessary operation of the heat sink fan may be prevented.

The plurality of heat sink fins include: first heat sink fins disposed on one side of the cover plate; and second heat sink fins disposed on one side of the heat sink fan.

A length the first heat sink fins protrude from the heat sink may be larger than a length the second heat sink fins protrude from the heat sink. This may increase the area of air flow in a space where the first heat sink fins are disposed.

Another embodiment of the present disclosure provides an energy storage apparatus including: a casing; a battery pack disposed inside the casing, with a plurality of battery cells placed therein; a power converter disposed inside the casing, for converting electrical characteristics to charge or discharge the plurality of battery cells; a pump that supplies cooling water to the battery pack or the power converter; and a heat radiator that cools cooling water flowing from the battery pack or the power converter, wherein the heat radiator includes: a housing disposed on one side of the casing, that forms a heat exchange space therein; a heat sink disposed in the heat exchange space of the housing, by which the heat exchange space is divided into a first chamber and a second chamber; a cooling water pipe disposed in the first chamber and configured to come into contact with the heat sink; and a heat sink fan disposed in the second chamber, that forms an air flow in the second chamber. Thus, heat can be dissipated from cooling water by using an outer space of the casing.

The heat sink fan may be disposed on one side of the housing, and a plurality of communicating holes vertically spaced out below the heat sink fan may be formed in the housing, wherein the plurality of communicating holes each allow the second chamber and the outside of the housing to communicate. Thus, the inflow of outside air may be increased through the plurality of communicating holes.

A plurality of heat sink fins may be disposed in the second chamber to guide air admitted into the communicating holes to the heat sink fan. Thus, the air flowing to the second chamber may come into contact with the plurality of heat sink fins and flow upward.

Yet another embodiment of the present disclosure provides an energy storage apparatus including: a casing; a battery pack disposed inside the casing, with a plurality of battery cells placed therein; a power converter disposed inside the casing, for converting electrical characteristics to charge or discharge the plurality of battery cells; a pump that supplies cooling water to the battery pack or the power converter; a first heat radiator that cools cooling water flowing from the battery pack or the power converter; a second heat radiator that cools cooling water flowing from the battery pack or the power converter; and a regulating valve that supplies cooling water flowing from the battery pack or the power converter to the first heat radiator or the second heat radiator, wherein the regulating valve is adjusted to supply cooling water to the second heat radiator alone when a temperature of cooling water flowing to the first heat radiator or the second heat radiator is less than or equal to a set temperature. Thus, the use of the first heat radiator and the second heat radiator may be regulated.

An energy storage apparatus of the present disclosure may offer one or more of the following effects.

First, a size of a heat radiator may be increased since the heat radiator is provided outside a casing. The increase in the size of the heat radiator can improve performance of the heat radiator and improve overall performance of the energy storage apparatus.

Second, a cooling water flow path may be expanded since a cooling water pipe may bend at one side of the casing and may be divided into branches. This can increase the area of heat exchange with cooling water and therefore improve heat exchange performance.

Third, efficient heat exchange may be provided across an entire space because a plurality of communicating holes formed in a cover plate and disposed remotely from a heat radiator may have a large area.

Fourth, performance of the energy storage apparatus may be improved by including a plurality of heat radiators and regulating operation of the heat radiators according to a temperature of cooling water.

The effects of the present disclosure are not limited to the foregoing, and other effects not mentioned herein will be able to be clearly understood by those skilled in the art from the description of the claims.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An energy storage apparatus comprising:
a casing;
a battery pack disposed inside the casing, and having a plurality of battery cells;
a power converter disposed inside the casing, and configured to charge or discharge the plurality of battery cells;
a pump configured to supply cooling liquid to the battery pack or the power converter; and
a heat radiator configured to cool the cooling liquid flowing from the battery pack or the power converter,
wherein the heat radiator includes:
a cooling pipe configured to guide flow of the cooling liquid;
a heat sink having a first side that contacts the cooling pipe and a second side having a plurality of heat sink fins disposed on the second side;
a heat sink fan disposed on one side of the heat sink, and configured to provide an air flow to the plurality of heat sink fins; and
a cover plate spaced from the heat sink in a first direction, and having a plurality of communicating holes through which air is to flow to the heat sink fins.

2. The energy storage apparatus of claim 1, wherein the plurality of heat sink fins protrude from the second side of the heat sink in the first direction toward the cover plate.

3. The energy storage apparatus of claim 1, wherein each of the plurality of heat sink fins extend in a second direction traverse to the first direction, and the plurality of heat sink fins are spaced apart from each other in a third direction perpendicular to the second direction.

4. The energy storage apparatus of claim 1, wherein the plurality of communicating holes are spaced on the cover plate in a second direction traverse to the first direction.

5. The energy storage apparatus of claim 1, wherein the plurality of communicating holes include a first communicating hole and at least one second communicating hole disposed above the first communicating hole in a second direction traverse to the first direction, and the first communicating hole has a larger aperture area than the at least one second communicating hole.

6. The energy storage apparatus of claim 5, wherein the at least one second communicating hole includes a plurality of second communicating holes spaced apart from each other in the second direction.

7. The energy storage apparatus of claim 5, wherein the plurality of heat sink fins are disposed above the first communicating hole.

8. The energy storage apparatus of claim 1, wherein the heat sink fan is disposed above the cover plate in a second direction traverse to the first direction.

9. The energy storage apparatus of claim 1, wherein the cooling pipe is disposed between the casing and the heat sink, and the cooling pipe includes a plurality of bending portions.

10. The energy storage apparatus of claim 1, wherein the cooling pipe includes:
a first cooling pipe disposed in a second direction on one side of the cover plate; and
a second cooling pipe that extends from the first cooling pipe and is disposed in the second direction on one side of the heat sink fan,
wherein the second cooling pipe has a plurality of tubes connected in parallel.

11. The energy storage apparatus of claim 1, wherein the heat radiator includes:
a first heat radiator; and
a second heat radiator disposed below the first heat radiator in a second direction traverse to the first direction,
wherein the first heat radiator and the second heat radiator each separately includes the cooling pipe, the heat sink having the plurality of heat sink fins, the heat sink fan, and the cover plate.

12. The energy storage apparatus of claim 11, comprising a regulating valve that selectively sends the cooling liquid to either the second heat radiator or to both the first and second heat radiators.

13. The energy storage apparatus of claim 12, wherein, when a temperature of the cooling liquid is less than or equal to a set temperature, the regulating valve is configured to supply the cooling liquid to only the second heat radiator.

14. The energy storage apparatus of claim 1, wherein the plurality of heat sink fins include:
first heat sink fins disposed to face the cover plate; and
second heat sink fins disposed to face the heat sink fan.

15. The energy storage apparatus of claim 14, wherein a length of the first heat sink fins in the first direction is larger than a length of the second heat sink fins in the first direction.

16. An energy storage apparatus comprising:
a casing;
a battery pack disposed inside the casing, and having a plurality of battery cells;
a power converter disposed inside the casing, and configured to charge or discharge the plurality of battery cells;
a pump configured to provide cooling liquid to the battery pack or the power converter; and
a heat radiator configured to cool the cooling liquid flowing from the battery pack or the power converter,
wherein the heat radiator includes:
a housing disposed on the casing, and configured to form a heat exchange space that has a first chamber and a second chamber;
a heat sink disposed in the heat exchange space of the housing;
a cooling pipe disposed in the first chamber and to directly contact the heat sink; and
a heat sink fan disposed in the second chamber, and configured to provide an air flow in the second chamber.

17. The energy storage apparatus of claim 16, wherein the heat sink fan is disposed on one side of the housing, and the housing includes a plurality of communicating holes vertically spaced out below the heat sink fan,
wherein the plurality of communicating holes are provided between the second chamber and outside of the housing to allow the air to flow in the second chamber.

18. The energy storage apparatus of claim 16, wherein a plurality of heat sink fins are disposed in the second chamber to guide air admitted through the communicating holes to the heat sink fan.

19. An energy storage apparatus comprising:
a casing;
a battery pack disposed inside the casing, and having a plurality of battery cells;
a power converter disposed inside the casing, and configured to charge or discharge the plurality of battery cells;
a pump configured to supply cooling liquid to the battery pack or the power converter;
a first heat radiator configured to cool the cooling liquid flowing from the battery pack or the power converter;
a second heat radiator configured to cool the cooling liquid flowing from the battery pack or the power converter; and
a regulating valve configured to selectively control the cooling liquid to the first heat radiator and the second heat radiator,
wherein the regulating valve is configured to supply the cooling liquid to the second heat radiator alone when a temperature of the cooling liquid is less than or equal to a set temperature.

20. The energy storage apparatus of claim 19, wherein the regulating valve is configured to supply the cooling liquid to both the first heat radiator and the second heat radiator alone when the temperature of the cooling liquid is greater than the set temperature.
